(19) United States
(12) Patent Application Publication
(10) Pub. No.: US 2022/0379330 A1
(43) Pub. Date: Dec. 1, 2022

(54) BLADDER-TYPE DISPENSING PUMP

(71) Applicant: Yaowu DING, Taixing (CN)

(72) Inventor: Yaowu DING, Taixing (CN)

(21) Appl. No.: 17/776,136

(22) PCT Filed: Dec. 29, 2020
(86) PCT No.: PCT/CN2020/140630

§ 371 Date: May 11, 2022

(30) Foreign Application Priority Data
Nov. 12, 2019 (CN) 201911099715.6

(51) Int. Cl. B05B 11/02; B05B 11/00

(52) U.S. Cl. CPC B05B 11/02; B05B 11/3074; B05B 11/3052

(57) ABSTRACT

A bladder-type dispensing pump (100) comprises a push nozzle (110) and a container cap (120), said nozzle (110) and cap (120) being interconnected. The push nozzle (110) is provided with a bladder portion (111). The bladder portion (111) is able to deform such that the volume of the internal cavity thereof may change. The bladder-type dispensing pump (100) is further provided with an elastic return mechanism. A portion of the elastic return mechanism is connected to or in contact with the bladder portion (111). When the bladder portion (111) is depressed so as to deform, the elastic return mechanism deforms with it, and when pressure acting on the bladder portion (111) is removed, the elastic return mechanism returns to its non-deformed state, causing the bladder portion (111) to reset.

### TECHNICAL FIELD

The present invention relates to an apparatus for dispensing a product in a liquid or semi-liquid state from a container, and in particular to a bladder-type dispensing pump.

### BACKGROUND ART

Liquid or semi-liquid products are often involved in the fields such as daily chemical products and foods, for example, soap solutions in an emulsion state, bath lotions, fluid foods, etc. Dispensing apparatuses, such as pumps, are often mounted on containers containing such products for dispensing the products in a liquid or semi-liquid state out of the containers to be used by consumers.

A conventional pump generally comprises an air cylinder and a piston reciprocating in the air cylinder, and sucks and pumps a product in a container by means of the reciprocating motion of the piston. In order to enable the piston to reciprocate, a spring, generally made of a metal, is provided in the pump to reset the piston.

Under the increasingly stringent environmental requirements, these conventional dispensing pumps present some problems. After the products in the containers are used up, it is required to recycle these containers and the dispensing pumps provided thereon. A main body of the dispensing pump is made of plastic, but the spring made of the metal is further included therein, so that during recycling, the dispensing pump needs to be disassembled, and the plastic and the metal of which the dispensing pump is made are separated and recycled separately. This results in an increase in the amount of work of recycling the dispensing pump and also increases the recovery cost thereof.

In response to this problem, many companies have endeavored to develop a dispensing pump with a new structure to replace the metal spring in the conventional dispensing pump. One of the solutions is to replace the metal spring in the conventional pump with a soft bladder. Specifically, a soft bladder is provided on a push head of the dispensing pump, and defines a variable-volume cavity inside the pump. By pressing the soft bladder, the volume of the cavity is changed so that suction and pumping actions on the product are achieved.

However, it is found in practice that the soft bladder has limited elastic properties compared to the elastic reset capacity of the metal spring, and therefore, some problems still arise during use. One of phenomena is that it is required to apply a large force when the soft bladder is pressed to pump the product to the outside; or, in another case, the soft bladder returning to its original undeformed state is relatively slow after the soft bladder is pressed, affecting the use experience of a user, or even in some cases where the pumping amount is large, the soft bladder cannot completely return to its original state, resulting in a gradual decrease in the output amount of the dispensing pump.

Therefore, there is still a need for further improvement of the structure of the dispensing pump in order to solve the problems in the prior art described above.

### SUMMARY OF THE INVENTION

The present invention is provided to solve the problems in the prior art described above. An object of the present invention is to provide a dispensing pump with an improved structure, in particular, a bladder-type dispensing pump which is capable of solving the problem of poor resilience of a soft bladder.

The present invention relates to a bladder-type dispensing pump for pumping a product out of a container, the pump comprising: a push head provided with a push nozzle; a container cap connected to the push head, and defining, together with the push head, an internal cavity of the bladder-type dispensing pump; a first one-way valve provided in a passage from the internal cavity to the push nozzle and configured to allow the product to enter the push nozzle, but to prevent backflow of the product from the push nozzle; and a second one-way valve provided in a passage from the interior of the container to the internal cavity and configured to allow the product to enter the internal cavity from the container, but to prevent backflow of the product from the bladder-type dispensing pump to the container. Moreover, the bladder-type dispensing pump further comprises a bladder portion provided on or connected to the push head, the bladder portion being deformable such that the volume of the internal cavity may be changed. In addition, the bladder-type dispensing pump is further provided with an elastic reset mechanism, a portion of the elastic reset mechanism being in contact with or connected to the bladder portion, when the bladder portion is pressed to deform, the elastic reset mechanism deforms together with the bladder portion, and when a pressure acting on the bladder portion is removed, the elastic reset mechanism returns to its undeformed state, causing the bladder portion to reset.

In the bladder-type dispensing pump described above, the elastic reset mechanism assists in recovery of the bladder portion by means of the elasticity thereof while the pumping of the product is achieved by using the resilience capability of the bladder portion, thereby returning to its original undeformed state more quickly and sufficiently. Thus, the bladder-type dispensing pump may be applicable to larger-output-volume application occasions, and the service life of the bladder-type dispensing pump may be prolonged.

Preferably, the elastic reset mechanism comprises at least one elastic strip, the upper end of the elastic strip being connected to an upper fixing ring, and the lower end of the elastic strip being connected to a lower fixing ring, wherein the upper fixing ring abuts against the bladder portion, and the lower fixing ring is supported on the container cap. Such a configuration allows the elastic reset apparatus to be made of plastic, namely, a plastic spring or the like may be used in the present invention so as to meet environmental recycling requirements.

Preferably, a preloading mechanism may be included in the bladder-type dispensing pump, wherein the preloading mechanism comprises: at least one first bump provided in the container cap and a second bump provided in the elastic reset apparatus, wherein the elastic reset mechanism is rotatable between a first position in which the first bump and the second bump are in contact with each other, and a second position in which the first bump and the second bump are staggered from each other. The arrangement of the preloading mechanism allows the elastic reset mechanism to be in a released state when not in use, thereby preventing the elastic reset mechanism from being subjected to yield deformation due to long-time pressing, and further prolonging the service life of the bladder-type dispensing pump.

Preferably, a synchronization mechanism is further provided between the push head and the elastic reset mechanism, and the synchronization mechanism is configured such that when the push head is rotated, the elastic reset mechanism rotates together with the push head.

The synchronization mechanism comprises: at least one guiding block provided on one of the push head and the elastic reset mechanism, and a groove formed in the other of the push head and the elastic reset mechanism, the groove being shaped to cooperate with the guiding block.

In a preferred configuration, the guiding block is suspended downwardly from an inner surface of the bladder portion of the push head.

Preferably, a deformable assisting portion is provided on the bladder portion, and the deformable assisting portion enables the bladder portion to easily deform when pressed. The arrangement of the deformable assisting portion allows the bladder portion to easily deform when the bladder portion is pressed, thereby reducing energy loss during pressing, and thus helping the bladder portion better return its undeformed state.

Preferably, the bladder portion is formed at the top of the push head, and the deformable assisting portion is at least one deformable coil formed on the bladder portion. In the case of a plurality of deformable coils, these deformable coils may be formed concentrically.

In another preferred configuration, a valve plate of the second one-way valve is integrally formed on the lower fixing ring, and a valve seat cooperating with the valve plate is formed in the container cap.

In a specific configuration, the first one-way valve is an elastic sheet formed on an inner sleeve of the push head and is aligned to the push nozzle, and an opening aligned to the elastic sheet is formed in an inner sleeve of the container cap, the elastic sheet being capable of closing the opening.

Preferably, the bladder-type dispensing pump is further provided with a balancing air hole, wherein the balancing air hole comprises: a vent hole formed in the container cap, the vent hole being in direct communication with the interior of the container; and a vent groove formed in the push head, the vent groove being in communication with the vent hole.

Alternatively, the balancing air hole may be structurally configured such that a vent hole is formed in the container cap, the vent hole being in direct communication with the interior of the container, and a sealing elastic sheet is provided at the lower portion of an outer sleeve of the push head, the sealing elastic sheet being located on the inner side of the balancing air hole. By providing the sealing elastic sheet, only outside air can flow into the container, and the product in the container cannot escape to the outside through the vent hole.

Preferably, a sealing plug is formed on the elastic reset mechanism, the sealing plug being configured such that the sealing plug is in sealing contact with the opening of the container cap when the elastic reset mechanism is in an uncompressed state, and gets out of contact with the opening when the elastic reset mechanism is pressed to deform.

Preferably, a circular projection is formed on the sealing elastic sheet and/or the sealing plug to further improve the sealing effect.

In a specific configuration, the elastic reset mechanism comprises at least one elastic strip, which is fixed to the push head and/or the container cap, extends on the outer side of the bladder portion, and cooperates with a protrusion formed on the outer side of the bladder portion.

In particular, the elastic reset mechanism may comprise an elastic strip, two ends of the elastic strip being fixed to the push head and/or the container cap, and the elastic strip being provided with a circular hole and a slot in communication with the circular hole, wherein the circular hole is sized to allow the protrusion to pass through the circular hole, and the slot is sized to snap-fit the protrusion at the slot.

Alternatively, the elastic reset mechanism may comprise two elastic strips, wherein one end of each elastic strip is fixed to the push head and/or the container cap, and the other end thereof is fixed to the protrusion.

In another specific configuration, the push head is movable relative to the container cap in a longitudinal direction of the bladder-type dispensing pump, the bladder-type dispensing pump further comprises a connecting rod connected between the container cap and the push head, the bladder portion is provided in the internal cavity, one end of the bladder portion is connected to the push head or the connecting rod, and the other end of the bladder portion is supported on the container cap.

Preferably, the upper end of the connecting rod is fixedly connected to the push head, and the lower end of the connecting rod is reciprocally movable relative to the container cap, wherein a sealing cap is provided at the lower end of the connecting rod, and the sealing cap is in sealing contact with a sealing ring provided in the container cap at an upper dead point of a stroke of the push head.

Preferably, in order to avoid the loss of the product in the container as a result of accidental pressing on the bladder portion of the bladder-type dispensing pump during storage, transportation and sales thereof, the bladder-type dispensing pump may further comprise an outer cover which is switchable between a covering position in which the bladder portion is covered and an opening position in which the bladder portion is exposed.

### BRIEF DESCRIPTION OF THE DRAWINGS

Non-limiting preferred embodiments of the present invention are illustrated in the accompanying drawings, and the features and advantages of the present invention will become more apparent in conjunction with the accompanying drawings. In the drawings:

FIG. 1a shows a cross-sectional view of a bladder-type dispensing pump of a first embodiment of the present invention.

FIG. 1b shows a partially cutaway perspective view of the bladder-type dispensing pump shown in FIG. 1a.

FIG. 2a shows a bottom perspective view of a push head of the bladder-type dispensing pump of the first embodiment shown in FIG. 1a.

FIG. 2b shows a cross-sectional view of the push head shown in FIG. 2a.

FIG. 3a shows a cross-sectional view of a container cap of the bladder-type dispensing pump of the first embodiment shown in FIG. 1a.

FIG. 3b shows a partially cutaway perspective view of the container cap shown in FIG. 3a.

FIG. 4a shows a bottom view of an elastic reset mechanism of the bladder-type dispensing pump of the first embodiment shown in FIG. 1a.

FIG. 4b shows a perspective view of the elastic reset mechanism shown in FIG. 4a.

FIG. 5a is a perspective view of a modified configuration of the bladder-type dispensing pump of the first embodiment of the present invention, in which the bladder-type dispensing pump further comprising an outer cover is illustrated.

FIG. 5b shows a perspective view of the bladder-type dispensing pump with another outer cover.

FIG. 6a shows a cross-sectional view of the bladder-type dispensing pump of a second embodiment of the present invention.

FIG. 6b shows a partially cutaway perspective view of the bladder-type dispensing pump shown in FIG. 6a.

FIG. 7 shows a top perspective view of an elastic reset mechanism of the bladder-type dispensing pump of the second embodiment shown in FIG. 6a.

FIG. 8 shows a bottom perspective view of the elastic reset mechanism shown in FIG. 7.

FIG. 9a shows a side view of a bladder-type dispensing pump of a third embodiment of the present invention.

FIG. 9b shows a cross-sectional view of the bladder-type dispensing pump taken along line A-A in FIG. 9a.

FIG. 10a shows a top view of an elastic strip of the bladder-type dispensing pump of the second embodiment shown in FIG. 9a.

FIG. 10b shows a cross-sectional view taken along line B-B in FIG. 10a.

FIG. 11 shows a cross-sectional view of a push head integrally formed with the elastic strip of the bladder-type dispensing pump of the third embodiment.

FIG. 12 shows a cross-sectional view of the bladder-type dispensing pump including the push head shown in FIG. 11.

FIG. 13a shows a side view of a modified configuration in the third embodiment of the present invention.

FIG. 13b shows a cross-sectional view of the bladder-type dispensing pump taken along line C-C in FIG. 13a.

FIG. 14a shows a perspective view of the push head of the bladder-type dispensing pump shown in FIG. 13a, with the elastic strip in a flat and straight state.

FIG. 14b shows another perspective view of the push head in FIG. 14a, in which the elastic strip is bent.

FIG. 15a shows a cross-sectional view of a bladder-type dispensing pump of a fourth embodiment of the present invention.

FIG. 15b shows a cross-sectional view of a push head of the bladder-type dispensing pump of the fourth embodiment shown in FIG. 15a.

FIG. 16a shows a cross-sectional view of a modified configuration in the fourth embodiment of the present invention.

FIG. 16b shows a cross-sectional view of a container cap of the bladder-type dispensing pump shown in FIG. 16a.

FIG. 17a shows a cross-sectional view of a bladder-type dispensing pump of a fifth embodiment of the present invention, in which the bladder-type dispensing pump is in an unpressed state.

FIG. 17b shows a cross-sectional view illustrating another state of the bladder-type dispensing pump shown in FIG. 17a, in which the bladder-type dispensing pump is pressed.

FIG. 18 shows a perspective view of an elastic reset mechanism of the bladder-type dispensing pump of the fifth embodiment shown in FIG. 17a.

FIG. 19 shows a perspective view of a push head of the bladder-type dispensing pump of the fifth embodiment shown in FIG. 17a.

FIG. 20a shows a cross-sectional view of a bladder-type dispensing pump of a sixth embodiment of the present invention, in which the bladder-type dispensing pump is in an unpressed state.

FIG. 20b shows a cross-sectional view illustrating another state of the bladder-type dispensing pump shown in FIG. 20a, in which the bladder-type dispensing pump is pressed.

FIG. 21 shows a sectional view of a bladder-type dispensing pump of a seventh embodiment of the present invention.

FIG. 22a is a perspective view of a first spring in the bladder-type dispensing pump in FIG. 21.

FIG. 22b is a perspective view of a second spring in the bladder-type dispensing pump in FIG. 21.

### DETAILED DESCRIPTION OF EMBODIMENTS

Particular embodiments of the present invention are described below in detail with reference to the accompanying drawings. It should be understood that only preferred embodiments of the present invention are shown in the accompanying drawings and are not intended to constitute a limitation to the scope of the present invention. Various obvious modifications, variations and equivalent substitutions to the present invention can be made by those skilled in the art based on the embodiments shown in the accompanying drawings, and the technical features in the different embodiments can be mutually combined in case of no conflict or unless otherwise specified. These all fall within the scope of protection of the present invention.

### First Embodiment

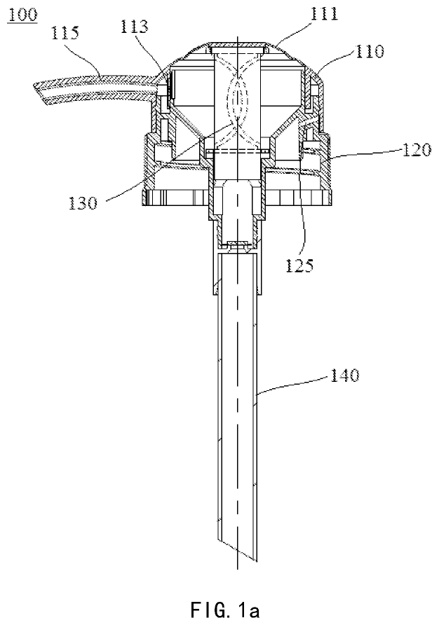

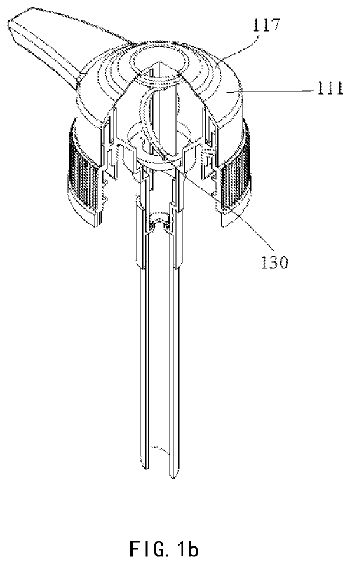

FIGS. 1a-5a show a bladder-type dispensing pump 100 and variations thereof according to a first embodiment of the present invention. FIG. 1a shows a cross-sectional view of the bladder-type dispensing pump 100, and FIG. 1b shows a perspective view of the bladder-type dispensing pump 100 in FIG. 1a, wherein the bladder-type dispensing pump 100 is partially cut away to more clearly illustrate components inside the bladder-type dispensing pump 100, including a spring 130 and so on.

The bladder-type dispensing pump 100 of the first embodiment shown in the figures comprises a push head 110, and the push head 110 is connected to a container cap 120 together and forms a cavity inside the bladder-type dispensing pump 100. For example, in the configuration shown in FIGS. 1a and 1b, the push head 110 and the container cap 120 are connected together by means of snap-fit connection. Of course, the connection between the push head 110 and the container cap 120 may also be achieved by screwing, welding, or other known connection manners. Moreover, the connection between the push head 110 and the container cap 120 may be fixed or relatively movable, which is within the scope of the present invention.

A suction tube 140 is connected to the lower portion of the container cap 120, and the suction tube 140 is capable of extending into a container such that a product in the container can enter the internal cavity of the bladder-type dispensing pump 100 via the suction tube 140 and is dispensed to the outside by a push nozzle 115 of the push head 110.

In the bladder-type dispensing pump 100 of the present invention, the push head 110 comprises a bladder portion 111, for example, a bladder portion 111 formed at the top of the push head 110 in the structure shown in FIGS. 1a and 1b. By pressing the bladder portion 111, the bladder portion 111 is deformable, and thus the volume of the internal cavity of the bladder-type dispensing pump 100 can be changed, namely, the volume of the cavity can be increased and decreased as the bladder portion 111 deforms, so that the product in the container is sucked and pumped to the outside.

The bladder-type dispensing pump 100 is further provided with an elastic reset apparatus acting on the bladder portion 111, which elastic reset apparatus is configured to assist the bladder portion 111 to return to its undeformed state after the bladder portion 111 is pressed to deform. As a whole, a portion of the elastic reset mechanism is in contact with the bladder portion 111 or may be connected to the bladder portion 111, and there is a further portion of the elastic reset mechanism separated from the bladder portion 111, which further portion is capable of remaining fixed relative to the container, namely, the elastic reset mechanism may further comprise a fixed portion. For example, the elastic reset apparatus may be a spring 130 that is described in detail below, one end (for example, the upper end) of the spring 130 is connected to or abuts against the bladder portion 111, the other end (for example, the lower end) thereof is supported on a supporting structure formed inside the bladder-type dispensing pump 100, such as a step portion, a rib or other structures formed on an inner surface of the push head 110 or the container cap 120, and thus the other end of the spring 130 can remain fixed relative to the container.

The structure of each component of the bladder-type dispensing pump 100 will be described separately below:

Push Head

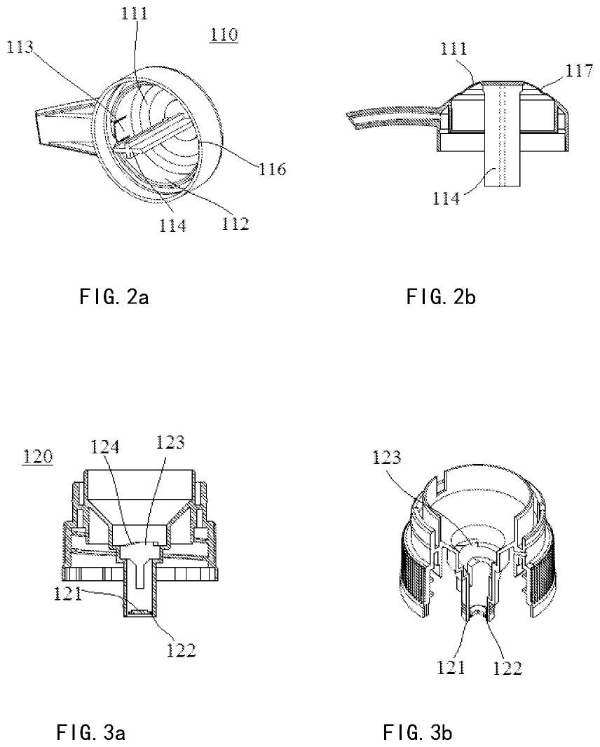

FIGS. 2a and 2b respectively show a perspective view and a side cutaway view of the push head 110. The top of the push head 110 is provided with the bladder portion 111 as described above, and an inner sleeve 112 is formed on an inner side of the push head 110; an upper one-way valve 113 is formed on the inner sleeve 112, and the upper one-way valve 113 is configured to open and close a passage of the push nozzle 115, thereby allowing the product to be delivered to the outside via the push nozzle 115 or preventing the product from being pumped out. In the configuration illustrated in the figures, the upper one-way valve 113 is in the form of an elastic sheet that deforms to open the passage to the push nozzle 115 when a pressure inside the bladder-type dispensing pump 100 rises, and that returns to its original state to close the passage to the push nozzle 115 when the pressure inside the bladder-type dispensing pump 100 drops.

Preferably, the bladder-type dispensing pump 100 of the present invention is provided with a synchronous rotation mechanism that is configured to allow the push head 110 to rotate together with the spring 130. In a preferred configuration illustrated in the figures, a guiding block 114 extending downwardly from the inner side of the top of the push head 110 is formed, and the guiding block 114 cooperates with a corresponding structure formed on the spring 130, which is to be described later, to form the synchronous rotation mechanism. The specific action principle of the synchronous rotation mechanism will be described in detail below.

In addition, preferably, a deformable assisting portion is further provided on the bladder portion 111, and the deformable assisting portion enables the bladder portion 111 to easily deform when the bladder portion 111 is pressed. For example, as shown in the figures, at least one undulating ring 117 is formed on the bladder portion 111, and the undulating ring 117 may be circular. More preferably, in the case of including a plurality of undulating rings 117, these undulating rings 117 may be concentrically circular.

By providing the deformable assisting portion, the bladder portion 111 more easily deforms when a user applies a pressing force to the bladder portion 111, and less pressing energy is absorbed when the bladder portion 111 deforms, so that the bladder portion 111 more easily returns to its original undeformed state after the pressing force is removed.

Container Cap

FIGS. 3a and 3b respectively show a cross-sectional view and a partially cutaway perspective view of the container cap 120. A lower one-way valve composed of a lower one-way valve plate 121 and a lower one-way valve seat 122 is provided at the lower portion of the inner side of the container cap 120. The lower one-way valve is configured to open when the pressure in the cavity in the bladder-type dispensing pump 100 drops to be lower than the pressure in the container so that the product in the container can enter the cavity of the bladder-type dispensing pump 100 via the suction tube 140, and to close when the pressure in the cavity rises to be higher than the pressure in the container so that the product in the container is prevented from entering the cavity.

An opening 126 aligned to the push nozzle 115 of the push head 110 and the upper one-way valve 113 is formed in the upwardly extending inner sleeve of the container cap 120. When the product is pumped outwardly, the elastic sheet of the upper one-way valve 113 is spaced from the opening 126 so as to allow the product to enter the push nozzle 115 and be pumped to the outside, and when the product is sucked from the container, the elastic sheet of the upper one-way valve 113 fits on the opening 126 to close the opening 126.

The upper one-way valve 113 may be integrally formed on the push head 110, or may be separately formed and connected to the push head 110.

In addition, the bladder-type dispensing pump 100 of the present invention preferably further comprises a preloading mechanism. In the structure of the container cap 120 shown in the figures, a first bump 123 is formed as a portion of the preloading mechanism, which cooperates with a corresponding structure on the spring 130 to play a preloading or releasing role on the spring 130. In a specific structure shown in FIGS. 3a and 3b, a first slope 124 is formed on the first bump 123, and the corresponding structure on the spring 130 may slide on the first slope 124, thereby switching the spring 130 between a loaded state and a released state.

A vent hole 125 is further preferably formed in the container cap 120, and the vent hole 125 is not in communication with the cavity of the push head 110, but is in direct communication with the interior of the container. Moreover, a vent groove 116 (FIG. 2a) in communication with the vent hole 125 is formed in the push head 110. Thus, while the bladder-type dispensing pump 100 is operated to pump the product out of the container, ambient air may be allowed to enter the container to compensate for the volume of the product that has been dispensed, thereby placing a negative pressure in the container.

Spring

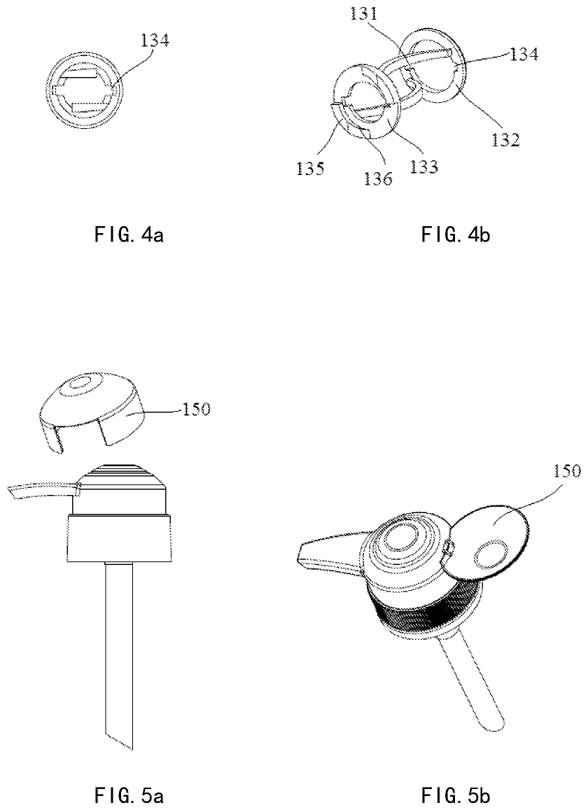

FIGS. 4a and 4b respectively show a bottom view and a perspective view of the spring 130. As shown in the figures, serving as a preferred structure of the elastic reset apparatus, the spring 130 comprises at least one elastic strip 131, an upper fixing ring 132 is connected to the upper end of the elastic strip 131, and a lower fixing ring 133 is connected to the lower end thereof. The upper fixing ring 132 may be in contact with or abuts against the bladder portion 111 of the push head 110, while the lower fixing ring 133 is supported on the container cap 120, such as providing the lower fixing ring on a supporting seat inside the inner sleeve of the container cap 120.

Preferably, the spring 130 comprises two or more elastic strips 131, and these elastic strips 131 may preferably not be bent on the same plane. Thus, these elastic strips 131 do not interfere with one another when the spring 130 is pressed.

As shown in FIGS. 3a and 3b, the first bump 123 is formed on the supporting seat. Correspondingly, a second bump 135 is formed on the bottom surface of the lower fixing ring 133 of the spring 130, and the second bump 135 interacts with the first bump 123 to form the preloading mechanism. When the top surfaces of the first bump 123 and the second bump 135 are in contact with each other, the lower fixing ring 133 of the spring 130 is in a raised position so that the spring 130 is preloaded, and when the first bump 123 and the second bump 135 are staggered from each other, the lower fixing ring 133 is in a lowered position so that the spring 130 is in the released state.

Preferably, a second slope 136 may be formed on the second bump 135, and under the interaction between the second slope 136 and the first slope 124, switching of the first bump 123 and the second bump 135 between a mutual contact state and a mutual staggered state may be facilitated, thereby preloading or releasing the spring 130.

The spring 130 may be switched between a preloaded position and a released position by rotating the push head 110. To this end, the upper fixing ring 132 of the spring 130 may be fixed to the push head 110, for example, fixed to the top of the push head 110, or fixedly connected to the bladder portion 111. Alternatively, as described above, the synchronous rotation mechanism is provided in the bladder-type dispensing pump 100, including the guiding block 114 formed in the push head 110 as described above. In cooperation with the guiding block 114, a guiding groove 134 is formed in the upper fixing ring 132 and/or the lower fixing ring 133 of the spring 130. The guiding groove 134 is sized to snap-fit in the guiding block 114 so that when the push head 110 is rotated, the guiding block 114 is capable of driving the spring 130 to rotate together, thereby allowing the second bump 135 on the spring 130 to be engaged with or disengaged from the first bump 123 on the container cap 120.

The arrangement of the preloading mechanism is particularly useful where the spring 130 is made of plastic. In a standby state, the spring 130 may be provided in the released position, and when it is to be used, the spring 130 may be provided in the preloaded position in advance. Thus, the spring 130 may be prevented from yielding due to the fact that the spring is in a long-term loaded state.

Outer Cover

Preferably, as shown in FIGS. 5a and 5b, the bladder-type dispensing pump 100 may further comprise an outer cover 150, and the outer cover 150 is configured to cover the push head 110, in particular the bladder portion 111, so as to protect the bladder portion 111 from accidental pressing. The outer cover 150 is particularly useful where the bladder-type dispensing pump 100 is in the process of storage, transportation and sales.

As shown in FIG. 5a, an example of the outer cover 150 is a separate cover detached from the push head 110. Also, in an example shown in FIG. 5b, the outer cover 150 is hinged to the push head 110 and is pivotable between an open position and a closed position.

Operating Method

The operating method of the bladder-type dispensing pump 100 constructed as described above will be further described below.

In the standby state, the bladder portion 111 of the push head 110 is in the undeformed state. In addition, where the preloading mechanism is included, the first bump 123 on the container cap 120 is staggered from the second bump 135 of the spring 130, so that the spring 130 is in the released state. In addition, the upper one-way valve 113 and the lower one-way valve are also in a closed state.

When the bladder-type dispensing pump 100 is to be operated for pumping the product in the container, a user optionally first rotates the push head 110, allowing the spring 130 to be switched from the released state to the preloaded state. Next, the user presses the bladder portion 111, so that the volume of the cavity in the bladder-type dispensing pump 100 is decreased, the pressure in the cavity rises until the pressure forces the upper one-way valve 113 to open, and the product in the cavity can thus be pushed into the push nozzle 115 and pumped to the outside via the push nozzle 115.

The user then stops applying the pressing force to the bladder portion 111, and the bladder portion 111 returns to its undeformed state under the action of resilience itself and the elasticity of the spring 130, increasing the volume of the cavity. As the volume of the cavity becomes large, the pressure therein is decreased to be lower than an external pressure and the pressure in the container. In this way, the upper one-way valve 113 is closed and the lower one-way valve is opened, so that the product in the container enters the cavity of the bladder-type dispensing pump 100. Thus, one pumping is completed.

It can be seen that, in this embodiment, by providing the spring 130 acting on the bladder portion 111, the bladder portion 111 can return to its initial undeformed state more quickly and sufficiently. Therefore, the bladder-type dispensing pump 100 may be applicable to larger-pumping-volume application occasions while being capable of still maintaining rapid recovery of the bladder portion 111 and maintaining its initial pumping capacity for a long time.

### Second Embodiment

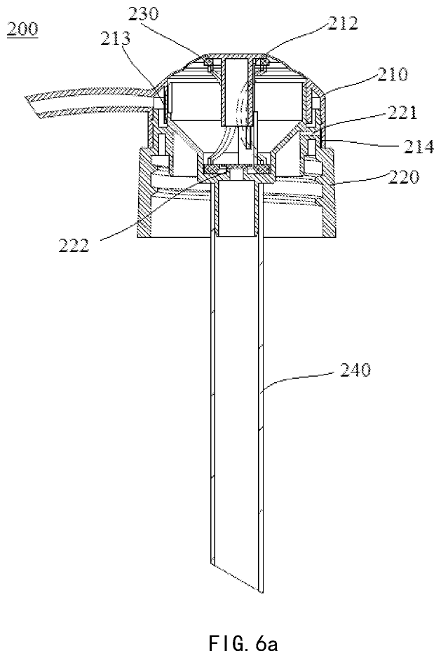

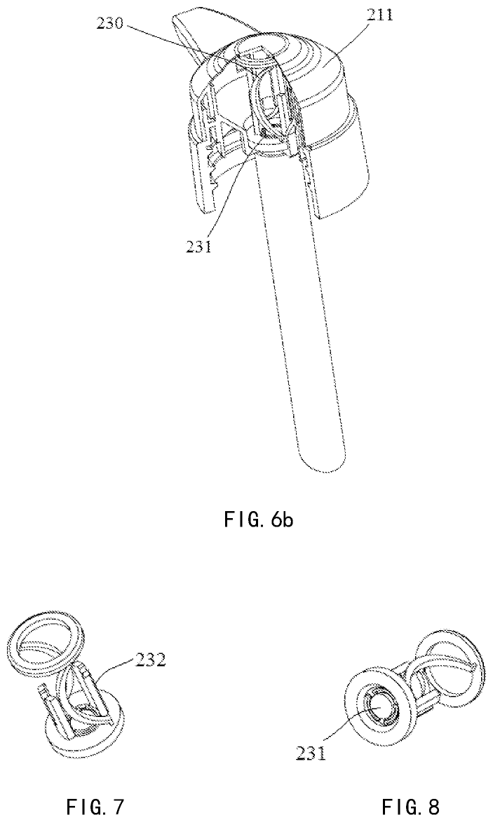

FIGS. 6a-8 show a bladder-type dispensing pump 200 of a second embodiment of the present invention. The same or corresponding features as those of the first embodiment are denoted by the same or like reference numerals, and the features different from the first embodiment are mainly described in the following disclosure, whereas the same features are not described in detail. The features described in the first embodiment are equally applicable to the second embodiment unless otherwise stated.

Similar to the push head 110 of the first embodiment, the bladder-type dispensing pump 200 comprises a push head 210 and a container cap 220 that are connected together, and further comprises a spring 230 as an elastic reset apparatus. The push head 210 comprises, for example, a bladder portion 211 formed at the top thereof, and one end of the spring 230 is in contact with the bladder portion 211 and is capable of applying an elastic force to the bladder portion 211 to help the bladder portion 211 return to its undeformed state. Also, a vent groove 214 is formed in the push head 210, and a vent hole 221 in communication with the vent groove 214 and the interior of the container is formed in the container cap 220, so that a balancing air passage is formed by the vent groove 214 and the vent hole 221.

In the bladder-type dispensing pump 200 of the second embodiment, a valve plate 231 of a lower one-way valve is integrally formed at the lower portion of the spring 230, as shown in FIGS. 7 and 8. In an exemplary structure shown in the figures, the valve plate 231 of the lower one-way valve is formed on a lower fixing ring of the spring 230, and the valve plate is integrally connected to the lower fixing ring by means of a plurality of elastic connecting members.

A valve seat 222 is formed on the container cap 220 to cooperate with the valve plate 231 on the spring 230 so as to open and close a passage from a suction tube 240 to an internal cavity of the bladder-type dispensing pump 200.

FIGS. 7 and 8 show perspective views of the spring 230 at two viewing angles, respectively. As shown in FIG. 7, a guiding fork 232 extending toward the upper fixing ring in a longitudinal direction is formed on the spring 230, particularly on the lower fixing ring of the spring 230, and the guiding fork 232 cooperates with a guiding block 212 formed on the push head 210, particularly suspended from the bladder portion 211, so that the push head 210 can drive the spring 230 to rotate together therewith when the push head is rotated. The valve plate 231 of the lower one-way valve integrally formed on the lower fixing ring of the spring 230 may be clearly seen from FIG. 8.

Furthermore, preferably, the upper one-way valve 213 may also be integrally formed on the push head 210, as shown in FIG. 6a.

### Third Embodiment

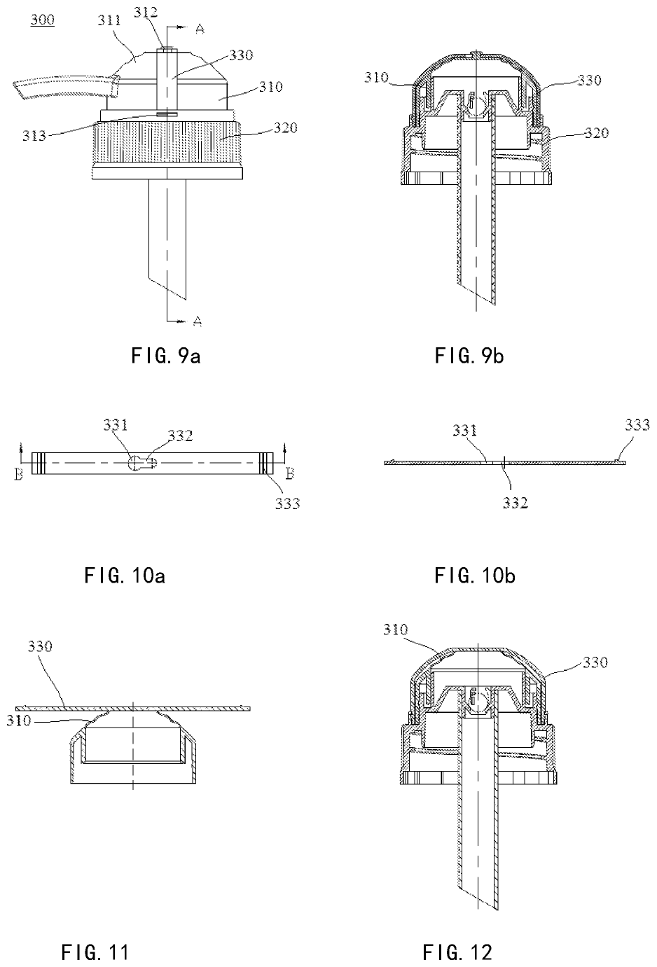

FIGS. 9a-14b show a bladder-type dispensing pump 300 of a third embodiment of the present invention and a bladder-type dispensing pump 300′ with a modified configuration thereof. The same or corresponding features as those of the first and second embodiments are denoted by the same or like reference numerals, and the features different from the first and second embodiments are mainly described in the following disclosure, whereas the same features are not described in detail. The features described in the first and second embodiments are equally applicable to the third embodiment unless otherwise stated.

As shown in FIGS. 9a and 9b, the bladder-type dispensing pump 300 of the third embodiment comprises a push head 310, a container cap 320 connected to the push head 310, and an elastic strip 330 functioning as an elastic reset apparatus, the elastic strip 330 being provided outside the push head 310 and extending at least around a periphery of the push head 310.

FIGS. 10a and 10b respectively show a top view and a cross-sectional view, taken along line A-A, of the elastic strip 330. It can be seen therefrom that two ends of the elastic strip 330 are respectively formed with a snap-fit portion 333, the snap-fit portion 333 cooperates with a mating groove 313 formed in the push head 310 or the container cap 320, so that the elastic strip 330 is fixedly installed on the bladder-type dispensing pump 300. In addition to the form of cooperation between the snap-fit portion 333 and the mating groove 313, the elastic strip 330 may be permanently or detachably fixed to the bladder-type dispensing pump 300 by other known means.

A circular hole 331 and a slot 332 in communication with the circular hole 331 are formed between the snap-fit portions 333 at the two ends of the elastic strip 330. In addition, a protrusion 312 (shown in FIG. 9a) is formed at the top of the push head 310. The protrusion 312 may have a larger-diameter top and a smaller-diameter rod. The diameter of the circular hole 331 may be greater than those of the top and the rod of the protrusion 312, and the width of the slot 332 may be less than the diameter of the top of the protrusion 312, but greater than the diameter of the rod of the protrusion 312.

Thus, when the elastic strip 330 is installed, the protrusion 312 first passes through the circular hole 331, and then the protrusion 312 is relatively moved in the longitudinal direction of the elastic strip 330, so that the protrusion 312 enters the slot 332 to snap-fit the protrusion 312 into the slot 332. The snap-fit portions 333 at the two ends of the elastic strip 330 are then respectively snap-fitted into the mating groove 313 in the push head 310 or the container cap 320 of the bladder-type dispensing pump 300, thereby completing the installation of the elastic strip 330.

In the third embodiment, the product in the internal cavity of the bladder-type dispensing pump 300 is pumped out by pressing the bladder portion 311, and meanwhile, the elastic strip 330 located outside the bladder portion 311 is also pressed to deform. The pressing force is then removed, the bladder portion 311, together with the elastic strip 330, returns to its undeformed state, and in this process, the elastic strip 330 will assist in the recovery of the bladder portion 311.

Further, the elastic strip 330 may be integrally formed with the bladder portion 311, as shown in FIGS. 11 and 12.

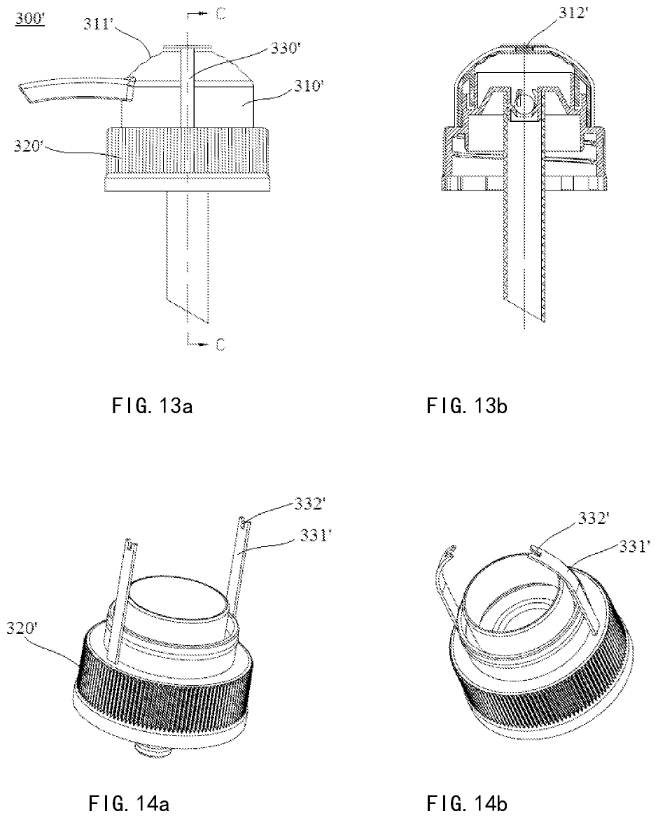

FIGS. 13a-14b show a bladder-type dispensing pump 300′ with a modified configuration of the third embodiment. In the modified configuration, an elastic component 330′ is integrally formed on a container cap 320 and cooperates with a protrusion 312′ formed at the top of a push head 310′.

Specifically, as shown in FIGS. 14a and 14b, the elastic component 330′ comprises two elastic strips 331′ integrally formed on the container cap 320′, and the two elastic strips 331′ are opposed to each other in a diameter direction of the container cap 320′. A snap groove 332′ is formed in the end of the elastic strip 331′ away from the container cap 320′, and the snap groove 332′ is snap-fitted to the protrusion 312′ formed at the top of the push head 310 by bending the elastic strip 331′, thereby completing the installation of the elastic component 330′.

In a further modified configuration, the elastic strip 330 may also be integrally formed on the push head 310′, which is as well within the scope of the present invention.

### Fourth Embodiment

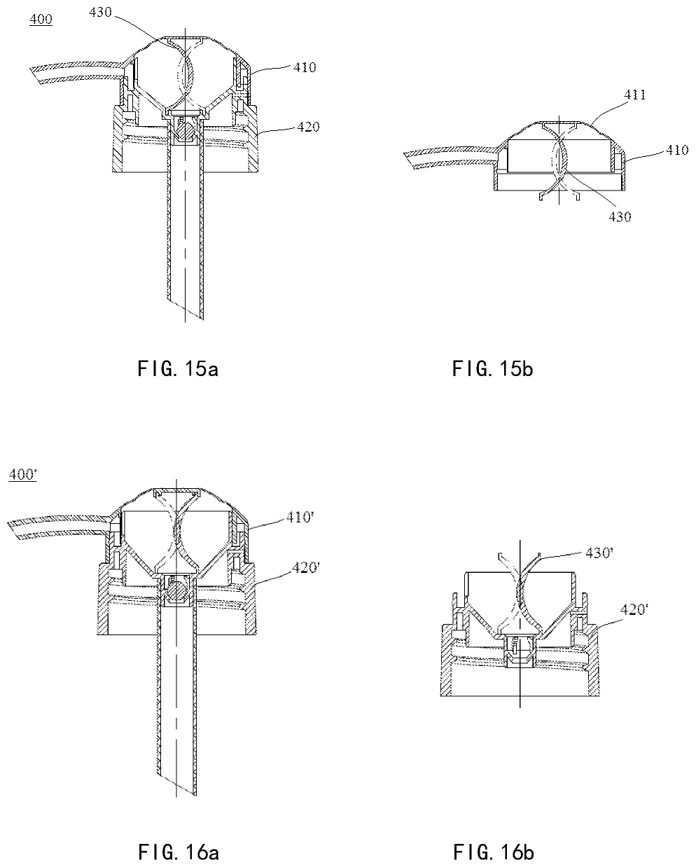

FIGS. 15a-16b show a bladder-type dispensing pump 400 of a fourth embodiment of the present invention and a modified configuration thereof. The same or corresponding features as those of the first to third embodiments are denoted by the same or like reference numerals, and the features different from the first to third embodiments are mainly described in the following disclosure, whereas the same features are not described in detail. The features described in the first to third embodiments are equally applicable to the fourth embodiment unless otherwise described.

As shown in FIG. 15a, the bladder-type dispensing pump 400 of the fourth embodiment comprises a push head 410 and a container cap 420 that are connected together, and a spring 430 is provided in an internal cavity of the bladder-type dispensing pump 400. One end of the spring 430 is supported on a supporting seat inside the container cap 420, and the other end thereof is integrally formed on the bladder portion 311 of the push head 410 as shown in FIG. 15b.

Alternatively, as shown in FIGS. 16a and 16b, in a bladder-type dispensing pump 400′ with a modified configuration, one end of a spring 430′ is integrally formed in a container cap 420′ (see FIG. 16b), and the other end thereof is supported in a bladder portion 411′ of a push head 410′.

### Fifth Embodiment

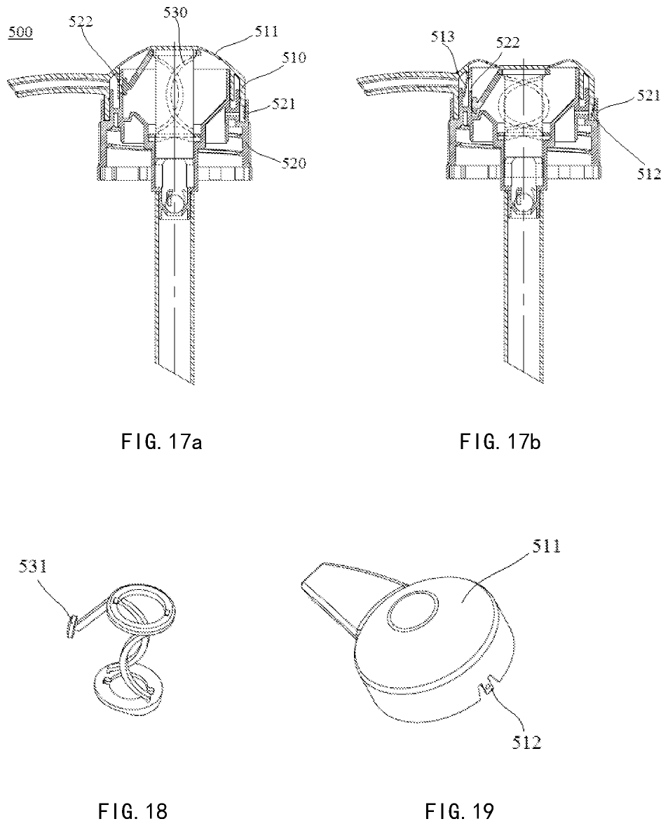

FIGS. 17a-19 show a bladder-type dispensing pump 500 of a fifth embodiment of the present invention. The same or corresponding features as those of the first to fourth embodiments are denoted by the same or like reference numerals, and the features different from the first to fourth embodiments are mainly described in the following disclosure, whereas the same features are not described in detail. The features described in the first to fourth embodiments are equally applicable to the fifth embodiment unless otherwise stated.

The bladder-type dispensing pump 500 of the fifth embodiment comprises a push head 510 and a container cap 520 that are connected together, a deformable bladder portion 511 is provided at the top of the push head 510, and an upper one-way valve 513 is further formed on the push head 510. A lower one-way valve is provided in the container cap 520, and a discharging port 522 aligned to the upper one-way valve 513 is formed in an inner sleeve of the container cap 520.

A spring 530 is provided in an internal cavity of the bladder-type dispensing pump 500, one end of the spring 530 is in contact with the bladder portion 211, and the other end thereof is supported on the container cap 520.

As shown in FIG. 18, in the fifth embodiment, the upper portion of the spring 530 is provided with a sealing plug 531. Preferably, the sealing plug 531 is formed on an upper fixing ring of the spring 530. When the bag-type dispensing pump 500 is in a standby state (FIG. 17a), the sealing plug 531 is aligned to the discharging port 522 and in sealing contact with the discharging port 522, and when the user presses down the bladder portion 511, the sealing plug 531 will move down together with the upper portion of the spring 530, thereby getting out of contact with the discharging port 522, and opening the discharging port 522 (FIG. 17b).

Preferably, a circular projection may be formed on the sealing plug 531 to further facilitate formation of sealing contact between the sealing plug 531 and the discharging port 522.

Furthermore, preferably, as shown in FIG. 19, the push head 510 of the bladder-type dispensing pump 500 of the fifth embodiment is further formed with a sealing elastic sheet 512, for example, the sealing elastic sheet 512 is formed at the lower portion of an outer sleeve of the push head 510, or may be formed at other portions of the push head 510 to be in contact with the container cap 520.

A balancing air hole 521 is formed in the container cap 520, and the balancing air hole 521 is provided at a position capable of being in communication with the container. When the bladder-type dispensing pump 500 is installed, the sealing elastic sheet 512 is located on an inner side of the balancing air hole 521 and sealingly covers the balancing air hole 521. Therefore, the sealing elastic sheet 512 functions as a one-way valve of the balancing air hole 521. Thus, outside air can enter the container through the balancing air hole 521, and the product in the container cannot escape from the balancing air hole 521 to the outside of the container.

Preferably, similar to the sealing plug 531, a circular projection may also be formed on the sealing elastic sheet 512 to further assist in sealing of the sealing elastic sheet 512 against the balancing air hole 521.

### Sixth Embodiment

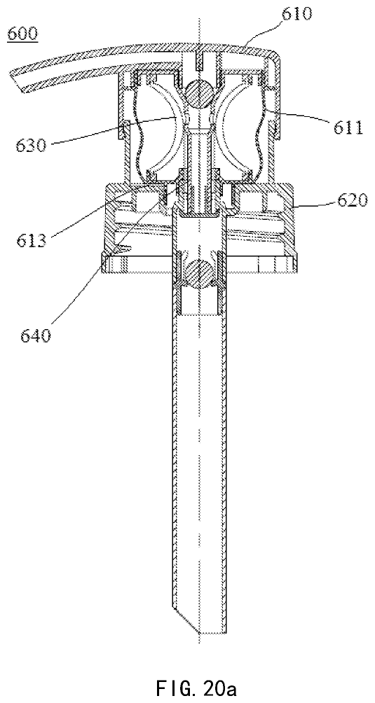

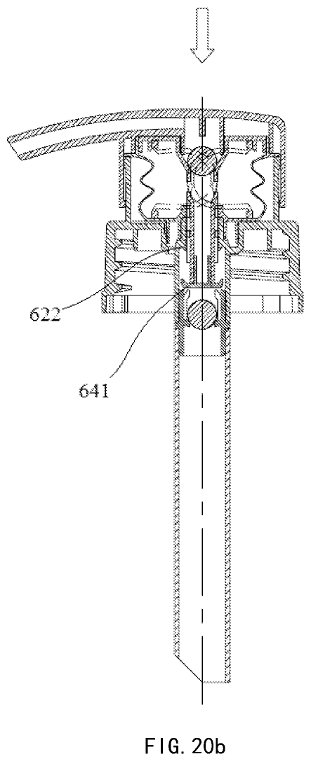

FIGS. 20a and 20b show a bladder-type dispensing pump 600 of a sixth embodiment of the present invention. The same or corresponding features as those of the first to fifth embodiments are denoted by the same or like reference numerals, and the features different from the first to fifth embodiments are mainly described in the following disclosure, whereas the same features are not described in detail. The features described in the first to fifth embodiments are equally applicable to the sixth embodiment unless otherwise stated.

As shown in FIGS. 20a and 20b, the bladder-type dispensing pump 600 of the sixth embodiment comprises a push head 610 and a container cap 620. The push head 610 may be connected to the container cap 620 relative to the container cap 620 in an axial direction of the bladder-type dispensing pump 600 in a reciprocating manner. In other words, the push head 610 may be pressed downward relative to the container cap 620.

The bladder-type dispensing pump 600 further comprises a connecting rod 640, the upper end of the connecting rod 640 is connected to the push head 610, and the lower end thereof is fitted in the container cap 620, which will be described in detail below. For example, thorns are provided at the upper and lower ends of the connecting rod 640 respectively, and the connection is achieved by means of the thorns and is movable. A sealing cap 641 is further provided at the lower end of the connecting rod 640, and a sealing ring 622 is correspondingly formed at the bottom of the container cap 620. When the push head 610 is at an upper dead point of a stroke thereof, the sealing cap 641 will be in contact with the sealing ring 622, and is preferably snapped on the sealing ring 622, thereby achieving sealing to prevent leakage of the product in the container.

A corrugated tube 611 (or soft bladder) is provided inside the bladder-type dispensing pump 600, one end (the upper end) of the corrugated tube 611 is connected to the push head 610, and the other end (the lower end) thereof is connected (or supported) to the container cap 620. The upper end of the corrugated tube 611 may rise or fall together with the push head 610. Also, when the push head 610 is rotated, the corrugated tube 611 may also be rotated together therewith.

Preferably, a first groove is formed in the bottom of the corrugated tube 611, and a second groove is formed in the container cap 620. The first groove and the second groove can cooperate with each other to form a balancing air passage 613.

When the first groove and the second groove are aligned to each other, they cooperate to form the above-mentioned balancing air passage 613, so that the pressures inside and outside the container can be balanced; and when the corrugated tube 611 rotates with the push head 610 to cause the first groove and the second groove to be staggered from each other, the balancing air passage 613 is closed.

The upper end of the connecting rod 640 may be fixedly connected to the push head 610, and the upper end of the corrugated tube 611 is fixedly connected to the upper end of the connecting rod 640.

### Seventh Embodiment

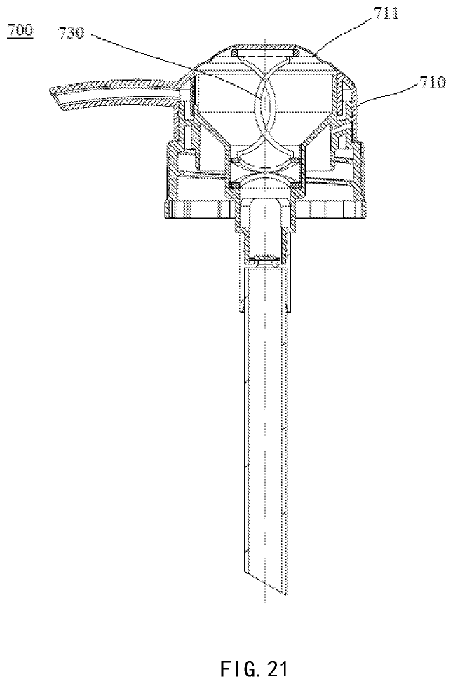

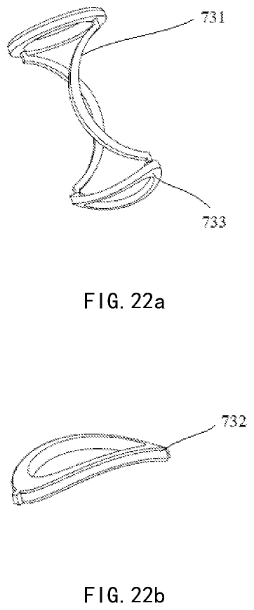

FIGS. 21-22b show a bladder-type dispensing pump 700 of a seventh embodiment of the present invention. The same or corresponding features as those of the first to sixth embodiments are denoted by the same or like reference numerals, and the features different from the first to sixth embodiments are mainly described in the following disclosure, whereas the same features are not described in detail. The features described in the first to sixth embodiments are equally applicable to the seventh embodiment unless otherwise stated.

FIG. 21 shows a cross-sectional view of the bladder-type dispensing pump 700 of the seventh embodiment. As can be seen, a push head 710 of the bladder-type dispensing pump 700 comprises a bladder portion 711, an elastic reset mechanism 730 being in contact with or connected to the bladder portion 711.

In the configuration shown in FIG. 21, the elastic reset mechanism 730 of the bladder-type dispensing pump 700 comprises two springs, namely, a first spring 731 and a second spring 732. FIGS. 22a and 22b respectively show perspective views of the first spring 731 and the second spring 732. As can be seen from the figures, a lower fixing ring 733 of the first spring 731 is in the shape of an arc protruding downwardly in a longitudinal direction of the bladder-type dispensing pump 700, while the second spring 732 is in the shape of an arc protruding upwardly in the longitudinal direction. The lower fixing ring 733 of the first spring 731 abuts against the second spring 732.

### Other Modified Configurations

The preferred embodiments of the present invention are described in detail with reference to the accompanying drawings. It will be apparent to those skilled in the art that obvious modifications and variations can be made on the basis of the above disclosed preferred embodiments without departing from the scope of the present invention.

For example, the synchronous rotation mechanism for rotating the elastic reset mechanism together with the push head may also take other forms. For example, the synchronous rotation mechanism may comprise two radially opposed bumps formed on the inner side of the inner sleeve, which two bumps cooperate with the grooves formed in the spring. Alternatively, the arrangement positions of the groove and the bump may be interchanged, namely, a groove is formed in the push head, and a rib is formed on a portion of the spring such as the upper fixing ring. It is even possible to directly fix the upper end of the spring to the push head.

In the preferred construction shown in the drawings, the elastic reset apparatus is a spring comprising an elastic strip, which allows to use a plastic spring in the bladder-type dispensing pump of the present invention, thereby facilitating environmental recycling. Of course, the elastic reset apparatus may also be in other forms, such as a helical spring.

In the embodiments disclosed above, such as in the first embodiment, the upper and lower one-way valves are in the form of a valve plate and a valve seat, and are formed on the container cap or the push head. In addition to this configuration, the upper and lower one-way valves may be in other forms known in the art, for example, the two one-way valves in FIG. 20b showing the sixth embodiment are in the form of a valve ball and a valve seat, with the upper one-way valve located in the connecting rod 640 and the lower one-way valve located in the suction tube. Furthermore, the upper and lower one-way valves may be located in other suitable positions as long as the flow of the product from an internal chamber of the dispensing pump to the push nozzle and the flow of the product from the container to the internal chamber can be controlled.

In the embodiments disclosed above, a portion of the elastic reset apparatus is connected to or in contact with the bladder portion, for example, the upper fixing ring in the first embodiment, the portion of the elastic strip 330 where the circular hole 331 and the slot 332 are located in the third embodiment, and so on, while another portion of the elastic reset apparatus is connected to the container cap or other portions of the push head other than the bladder portion. Of course, the portion of the elastic reset apparatus that is not in contact with or partly with the bladder portion may also be provided on other parts of the dispensing pump that are fixed relative to the container, such as the suction tube. Even, the portions of the elastic reset apparatus outside the bladder portion may also be directly fixed to the container, for example, supported at a shoulder or a mouth of the container, which are also within the scope of the present invention.

In the embodiments disclosed above, the elastic reset mechanism may comprise one spring (first to sixth embodiments) or two springs (seventh embodiment). It will be appreciated that the elastic reset mechanism may also include other numbers of springs, such as three, four or more, depending on the requirements of a particular application occasion.

1. A bladder-type dispensing pump for pumping a product out of a container, the pump comprising:
a push head provided with a push nozzle;
a container cap connected to the push head, and defining, together with the push head, an internal cavity of the bladder-type dispensing pump;
a first one-way valve provided in a passage from the internal cavity to the push nozzle and configured to allow the product to enter the push nozzle, but to prevent backflow of the product from the push nozzle; and
a second one-way valve provided in a passage from the interior of the container to the internal cavity and configured to allow the product to enter the internal cavity from the container, but to prevent backflow of the product from the bladder-type dispensing pump to the container;
wherein the bladder-type dispensing pump further comprises a bladder portion provided on or connected to the push head, the bladder portion being deformable such that the volume of the internal cavity may be changed, and the bladder-type dispensing pump is further provided with an elastic reset mechanism, a portion of the elastic reset mechanism being in contact with or connected to the bladder portion, when the bladder portion is pressed to deform, the elastic reset mechanism deforms together with the bladder portion, and when a pressure acting on the bladder portion is removed, the elastic reset mechanism returns to its undeformed state, causing the bladder portion to reset.

2. The bladder-type dispensing pump of claim 1, wherein the elastic reset mechanism comprises at least one elastic strip, the upper end of the elastic strip being connected to an upper fixing ring, and the lower end of the elastic strip being connected to a lower fixing ring; wherein the upper fixing ring abuts against the bladder portion, and the lower fixing ring is supported on the container cap.

3. The bladder-type dispensing pump of claim 2, wherein the bladder-type dispensing pump comprises a preloading mechanism, wherein the preloading mechanism comprises:
at least one first bump provided in the container cap, and
a second bump provided in the elastic reset mechanism,
wherein the elastic reset mechanism is rotatable between a first position in which the first bump and the second bump are in contact with each other, and a second position in which the first bump and the second bump are staggered from each other.

4. The bladder-type dispensing pump of claim 1, wherein a synchronization mechanism is further provided between the push head and the elastic reset mechanism, and the synchronization mechanism is configured such that when the push head is rotated, the elastic reset mechanism rotates together with the push head.

5. The bladder-type dispensing pump of claim 4, wherein the synchronization mechanism comprises:
at least one guiding block provided on one of the push head and the elastic reset mechanism, and
a groove formed in the other of the push head and the elastic reset mechanism, the groove being shaped to cooperate with the guiding block.

6. The bladder-type dispensing pump of claim 5, wherein the guiding block is suspended downwardly from an inner surface of the bladder portion of the push head.

7. The bladder-type dispensing pump of claim 1, wherein a deformable assisting portion is provided on the bladder portion, and the deformable assisting portion enables the bladder portion to easily deform when pressed.

8. The bladder-type dispensing pump of claim 7, wherein the bladder portion is formed at the top of the push head, and the deformable assisting portion is at least one deformable coil formed on the bladder portion.

9. The bladder-type dispensing pump of claim 2, wherein a valve plate of the second one-way valve is integrally formed on the lower fixing ring, and a valve seat cooperating with the valve plate is formed in the container cap.

10. The bladder-type dispensing pump of claim 1, wherein the first one-way valve is an elastic sheet formed on an inner sleeve of the push head and aligned to the push nozzle, and
an opening aligned to the elastic sheet is formed in an inner sleeve of the container cap, the elastic sheet being capable of closing the opening.

11. The bladder-type dispensing pump of claim 1, wherein the bladder-type dispensing pump is further provided with a balancing air hole, wherein the balancing air hole comprises:
a vent hole formed in the container cap, the vent hole being in direct communication with the interior of the container; and
a vent groove formed in the push head, the vent groove being in communication with the vent hole.

12. The bladder-type dispensing pump of claim 11, wherein the vent hole is formed in the container cap and is in direct communication with the interior of the container, and a sealing elastic sheet is provided at the lower portion of an outer sleeve of the push head and is located on the inner side of the balancing air hole.

13. The bladder-type dispensing pump of claim 10, wherein a sealing plug is formed on the elastic reset mechanism, and is configured such that the sealing plug is in sealing contact with the opening of the container cap when the elastic reset mechanism is in an uncompressed state, and gets out of contact with the opening when the elastic reset mechanism is pressed to deform.

14. The bladder-type dispensing pump of claim 12, wherein a circular projection is formed on the sealing elastic sheet.

15. The bladder-type dispensing pump of claim 13, wherein a circular projection is formed on the sealing plug.

16. The bladder-type dispensing pump of claim 1, wherein the elastic reset mechanism comprises at least one elastic strip, which is fixed to the push head and/or the container cap, extends on the outer side of the bladder portion, and cooperates with a protrusion formed on the outer side of the bladder portion.

17. The bladder-type dispensing pump of claim 16, wherein the elastic reset mechanism may comprise one of the elastic strips, two ends of the elastic strip being fixed to the push head and/or the container cap, and the elastic strip being provided with a circular hole and a slot in communication with the circular hole,
wherein the circular hole is sized to allow the protrusion to pass through the circular hole, and the slot is sized to snap-fit the protrusion at the slot.

18. The bladder-type dispensing pump of claim 16, wherein the elastic reset mechanism comprises two of the elastic strips, one end of each of the elastic strips being fixed to the push head and/or the container cap, and the other end being fixed to the protrusion.

19. The bladder-type dispensing pump of claim 1, wherein the push head is movable relative to the container cap in a longitudinal direction of the bladder-type dispensing pump, and the bladder-type dispensing pump further comprises a connecting rod connected between the container cap and the push head; and
the bladder portion is provided in the internal cavity, one end of the bladder portion is connected to the push head or the connecting rod, and the other end of the bladder portion is supported on the container cap.

20. The bladder-type dispensing pump of claim 19, wherein the upper end of the connecting rod is fixedly connected to the push head, and the lower end of the connecting rod is reciprocally movable relative to the container cap; wherein a sealing cap is provided at the lower end of the connecting rod, and the sealing cap is in sealing contact with a sealing ring provided in the container cap at an upper dead point of a stroke of the push head.

21. The bladder-type dispensing pump of claim 1, wherein the bladder-type dispensing pump further comprises an outer cover which is switchable between a covering position in which the bladder portion is covered and an opening position in which the bladder portion is exposed.
